(19) United States
(12) Patent Application Publication
(10) Pub. No.: US 2026/0205805 A1
(43) Pub. Date: Jul. 16, 2026

(54) METHOD AND APPARATUS FOR IMPROVING SECURITY AGAINST FALSE BASE STATION

(71) Applicant: Samsung Electronics Co., Ltd., Suwon-si (KR)

(72) Inventors: Taehyung LIM, Suwon-si (KR); Hongjin CHOI, Suwon-si (KR); June HWANG, Suwon-si (KR); Sangsoo JEONG, Suwon-si (KR); Hoyeon LEE, Suwon-si (KR)

(21) Appl. No.: 19/445,366

(22) Filed: Jan. 9, 2026

(30) Foreign Application Priority Data
Jan. 10, 2025 (KR) 10-2025-0004180

(51) Int. Cl. H04W 12/0431; H04W 4/90; H04W 12/06; H04W 48/20

(52) U.S. Cl. CPC H04W 12/0431; H04W 4/90; H04W 12/06; H04W 48/20

(57) ABSTRACT

The disclosure relates to a 5G or 6G communication system for supporting a higher data transmission rate. A method for identifying a base station by a user equipment (UE) in a communication system may include receiving, from the base station, a first message including information for an operation to be performed by the UE, transmitting, to the base station, a second message including request information for verifying the first message, receiving, from the base station, a third message including information for verifying the first message, and determining authenticity of the base station by using the third message.

### CROSS-REFERENCE TO RELATED APPLICATION

This application is based on and claims priority under 35 U.S.C. § 119 to Korean Patent Application No. 10-2025-0004180, filed on January 10, 2025, in the Korean Intellectual Property Office, the disclosure of which is herein incorporated by reference in its entirety.

### TECHNICAL FIELD

The disclosure relates to a wireless communication system and, more particularly, to a method and apparatus for preventing security threats that may be caused by a false base station.

### BACKGROUND

5G mobile communication technologies define broad frequency bands such that high transmission rates and new services are possible, and can be implemented not only in “Sub 6GHz” bands such as 3.5GHz, but also in “Above 6GHz” bands referred to as mmWave including 28GHz and 39GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure provides a method and an apparatus for improving security against a false base station.

To solve the above problem, a method for identifying a base station by a user equipment (UE) in a communication system according to an embodiment of the disclosure may include receiving, from a base station, a first message including information for an operation performed by the UE, transmitting, to the base station, a second message including request information for verifying the first message, receiving, from the base station, a third message including information for verifying the first message, and determining authenticity of the base station by using the third message.

Various embodiments of the disclosure can eliminate security threats that may be caused by a false base station by providing a method and an apparatus for enabling a UE to identify authenticity of a base station that has transmitted information, or authenticity of information transmitted by a base station.

When a UE performs an operation based on false information transmitted by a false base station without distinguishing the false information, various security threats including access disruption may occur. In order to eliminate the security threats to the UE, the UE is required to distinguish a false base station or false information transmitted by the false base station. The UE may provide a method and an apparatus for identifying authenticity of information received from a base station, or authenticity of a base station that has transmitted information, thereby eliminating a security threat.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a network architecture of a 5G system according to an embodiment of the disclosure;

FIG. 2 illustrates a method for a UE to identify authenticity of a base station according to an embodiment of the disclosure;

FIG. 3 illustrates a process of transmitting and receiving information for identifying authenticity of a base station according to an embodiment of the disclosure;

FIG. 4 illustrates a process of transmitting and receiving information for identifying authenticity of a base station according to an embodiment of the disclosure;

FIG. 5 illustrates a process of transmitting and receiving information for identifying authenticity of a base station according to an embodiment of the disclosure;

FIG. 6 illustrates a process of transmitting and receiving information for identifying authenticity of a base station according to an embodiment of the disclosure;

FIG. 7 illustrates a process of transmitting and receiving information for identifying authenticity of a base station according to an embodiment of the disclosure;

FIG. 8 illustrates a process of transmitting and receiving information for identifying authenticity of a base station according to an embodiment of the disclosure;

FIG. 9 illustrates a process of transmitting and receiving information for identifying authenticity of a base station according to an embodiment of the disclosure;

FIG. 10 illustrates a process of transmitting and receiving information for identifying authenticity of a base station according to an embodiment of the disclosure;

FIG. 11 illustrates a structure of a UE according to an embodiment of the disclosure; and

FIG. 12 illustrates a structure of a base station according to an embodiment of the disclosure.

### DETAILED DESCRIPTION

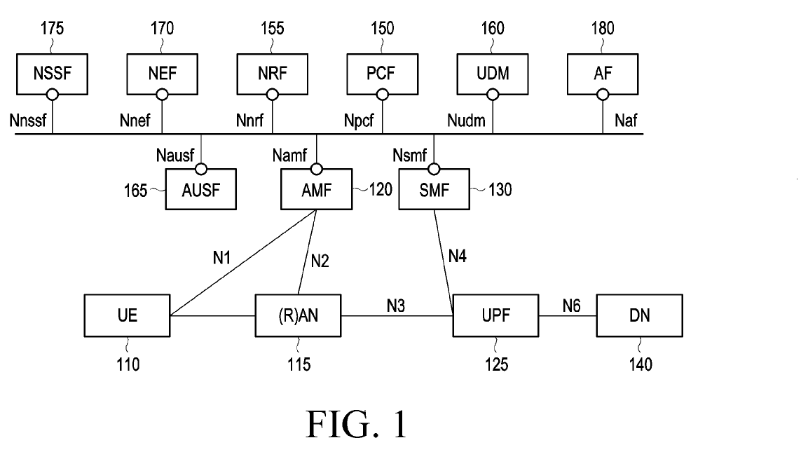

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

The 3rd generation partnership project (3GPP), which is responsible for cellular mobile communication standards, is promoting standardization of a new core network architecture named the 5G core (5GC) in order to evolve from the 4G long term evolution (LTE) system to a 5G system. The 5GC supports differentiated functions compared to the evolved packet core (EPC), which is a core network for the 4G.

First, a network slice function is introduced in the 5GC. As one of the requirements of 5G, the 5GC may support various types of UEs and services (e.g., eMBB, URLLC, or mMTC services). Various types of services have different requirements for core networks. For example, eMBB requires a high data rate, while URLLC requires high reliability and low latency. One of the technologies provided to meet such diverse service requirements is network slicing.

Network slicing is a method of virtualizing a single physical network into multiple logical networks, and each network slice instance (NSI) may have different characteristics. Accordingly, each NSI may include a network function (NF) corresponding to the characteristics thereof, thereby satisfying diverse service requirements. When an NSI corresponding to the characteristics of the service required by each UE is allocated, various 5G services may be efficiently supported.

Second, the 5GC may facilitate support for the network virtualization paradigm by separating mobility management functions and session management functions. In the 4G LTE system, a UE could be provided with services through signaling exchange with a single core entity, referred to as a mobility management entity (MME), which is responsible for registration, authentication, mobility management, and session management for all UEs. However, in the 5G system, the number of UEs explosively increases, and the mobility and traffic/session characteristics to be supported are subdivided according to the type of UE. If a single entity such as the MME were to support all of these functions, scalability in terms of adding entities for each required function would inevitably be degraded. Therefore, in order to improve scalability in terms of functional/implementation complexity of the core entity responsible for the control plane and signaling load, various functions are being developed based on a structure in which mobility management functions and session management functions are separated.

Hereinafter, various embodiments will be described in detail in conjunction with the accompanying drawings. In describing embodiments of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in various embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card.

In the following description, a base station is an entity that allocates resources to terminals, and may be at least one of an eNode B (eNB), a Node B, a base station (BS), a radio access network (RAN), an access network (AN), a RAN node, a NR NB, a gNB, a wireless access unit, a base station controller, and a node on a network. A terminal may include a user equipment (UE), a mobile station (MS), a cellular phone, a smartphone, a computer, or a multimedia system capable of performing a communication function. In various embodiments of the disclosure, the case where the terminal is a UE will be described by way of example. Furthermore, in the following description of various embodiments, systems based on LTE, LTE-A, or NR may be described by way of example, but various embodiments of the disclosure may also be applied to other communication systems having similar technical backgrounds or channel types. Moreover, based on determinations by those skilled in the art, various embodiments of the disclosure may also be applied to other communication systems through some modifications without significantly departing from the scope of the embodiments of the disclosure.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications. Hereinafter, some terms used in a core network of the disclosure will be defined before explanation:
AMF Access and Mobility Management Function;
SMF Session Management Function;
PCF Policy Control Function;
UPF User Plane Function;
AUSF Authentication Server Function;
UDM User Data Management;
AF Application Function;
NSSF Network Slice Selection Function;
NRF Network Slice Selection Function; and
NEF Network Exposure Function.

FIG. 1 illustrates a network architecture for a 5G system according to an embodiment of the disclosure.

The unit that performs each of function provided in a 5G network system may be defined as a network function (NF). The structure of the 5G mobile communication network is illustrated in FIG. 1. Representative NFs include an access and mobility management function (AMF) 120, which manages network access and mobility of a UE 110, a session management function (SMF) 130, which performs functions related to sessions for a UE, a user plane function (UPF) 125, which is responsible for transferring user data and is controlled by the SMF, an application function (AF) 180, which communicates with the 5GC to provide services, a network exposure function (NEF) 170, which supports communication between the 5GC and the AF 180, unified data management (UDM) and a unified data repository (UDR) 160, which store and manage data, a policy control function (PCF) 150, which manages policy, and a data network (DN) 140, such as the Internet, through which user data is transferred. In addition to the NF, an operation, administration, and management (OAM) system (not shown) may exist to manage the UE and the 5G mobile communication network. Session information may include QoS information, charging information, and information on packet processing. The 5G network system may further include a base station (BS) 115, an authentication server function (AUSF) 165, a network slice selection function (NSSF) 175, and a network repository function (NRF) 155. The structure of the 5G mobile communication network may include a radio access network (RAN) 115 or an access network (AN) 115.

In embodiments to be described below, the following terms may be commonly used:

PSM: Public Signing Material;

SSM: Secret Signing Material;

PVT: Public Validation Token;

SSK: Secret Signing Key;

KPAK: Key Management Service Public Authentication Key;

UE: User Equipment;

BS: Base Station;

INFO: Information;

TS: Time Stamp; and

RN: Random Number.

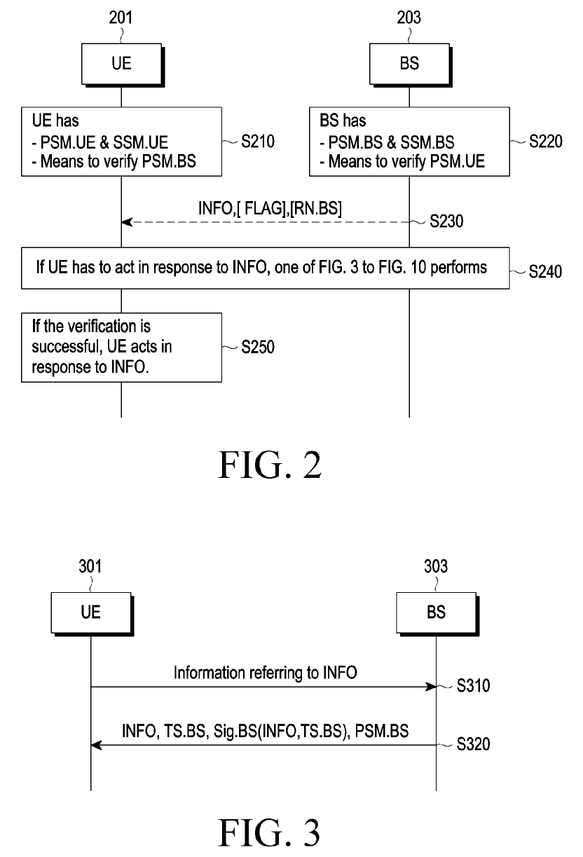

FIG. 2 illustrates a method for a UE to identify authenticity of a base station according to an embodiment of the disclosure.

Referring to FIG. 2, a UE 201 may perform preliminary operations required for an embodiment of a method of identifying authenticity of a base station 203. The UE 201 may perform an authenticity verification process in order to identify authenticity of the base station 203. The UE 201 may perform an operation subsequent to identify authenticity of the base station 203.

In S210, one or more of the following processes may be performed.

The UE may have one or more of the following pieces of information:

PSM.UE;

SSM.UE; and/or

Means for verifying PSM.BS.

When signing and verification operate on a certificate, PSM.UE and/or SSM.UE and/or means for verifying PSM.BS may be as follows:

PSM.UE: a public key of the UE that enables verification of a signature value signed with SSM.UE and/or proof information indicating that the public key is owned by the UE (the PSM.UE may be a certificate);

SSM.UE: a secret signing key used for a signature of the UE; and/or

Means for verifying PSM.BS: means for verifying proof information indicating that a public key included in PSM.BS is owned by a specific BS (e.g., a public key of a CA used to generate proof information indicating that the public key included in PSM.BS is owned by the specific BS, or a certificate including the public key of the CA).

When signing and verification operate on identity-based cryptography, PSM.UE and/or SSM.UE and/or means for verifying PSM.BS may be as follows:

PSM.UE: ID.UE and/or PVT.UE that enables verification of a signature value signed with SSM.UE;

SSM.UE: SSK.UE used for a signature of the UE; and/or

Means for verifying PSM.BS: means for verifying that PVT.BS is owned by a specific BS (e.g., KPAK of a CA managing PVT.BS).

In S220, one or more of the following processes may be performed.

The base station may have one or more of the following pieces of information:

PSM.BS;

SSM.BS; and/or

Means for verifying PSM.UE.

When signing and verification operate on a certificate, PSM.BS and/or SSM.BS and/or means for verifying PSM.UE may be as follows:

PSM.BS: a public key of the BS that enables verification of a signature value signed with SSM.BS and/or proof information indicating that the public key is owned by the BS (the PSM.BS may be a certificate);

SSM.BS: a secret signing key used for a signature of the BS; and/or

Means for verifying PSM.UE: means for verifying proof information indicating that a public key included in PSM.UE is owned by a specific UE (e.g., a public key of a CA used to generate proof information indicating that the public key included in PSM.UE is owned by the specific UE, or a certificate including the public key of the CA).

When signing and verification operate on identity-based cryptography, PSM.BS and/or SSM.BS and/or means for verifying PSM.UE may be as follows:

PSM.BS: ID.BS and/or PVT.BS that enables of verification of a signature value signed with SSM.BS;

SSM.BS: SSK.BS used for a signature of the BS; and/or

Means for verifying PSM.UE: means for verifying that PVT.UE is owned by a specific UE (e.g., KPAK of a CA managing PVT.UE).

In S230, one or more of the following processes may be performed.

The BS may perform one or more of the following processes.

The BS may transmit one or more of the following items to the UE. The BS may be referred to as a base station. The BS may transmit a first message to the UE. The first message may include information for an operation to be performed by the UE. In other words, the first message may include information regarding an operation to be performed by the UE. The first message may include at least one of INFO, FLAG, or RN.BS:

INFO: a series of pieces of information required in a process in which the UE camps on the BS (e.g., cell (re)selection parameters, neighbor cell information, frequency priority, blocklisted cell information, common channel configuration information, etc.) and/or a public warning system (PWS) message;

FLAG: information indicating that the BS is equipped with a base station authenticity verification function described in the disclosure; and/or

RN.BS: information used in a process of verifying the UE by the BS in some embodiments of the disclosure, for example, an RN generated by the BS.

In S240, one or more of the following processes may be performed.

When there is no operation to be performed as a result of the INFO received in S230, the UE may ignore the received INFO.

When there is an operation is to be performed as a result of the INFO received in S230, the UE may perform an operation described in the embodiments illustrated in FIG. 3 to FIG. 10. In S240, the UE may transmit a second message to the BS. The BS may receive the second message transmitted by the UE. The second message may include request information for verifying the first message. The second message may include information indicating information that requires verification. In S240, the BS may transmit a third message to the UE. The UE may receive the third message from the BS. The third message may include information for verifying the first message. The third message may include at least one of TS.BS, Sig.BS, PSM.BS, and INFO, which is the information for which the UE has requested verification.

In S250, one or more of the following processes may be performed.

The UE may perform one or more of the following processes.

When there is an operation is to be performed as a result of the INFO received in 230, and the operation described in the embodiments illustrated in FIG. 3 to FIG. 10 has been performed in S240, the UE may verify authenticity of the information received from the BS. The verification may be performed using “PSM.BS received from the BS” and “means for verifying PSM.BS possessed by the UE.” (For example, the validity of the received PSM.BS may be verified using the “means for verifying PSM.BS possessed by the UE,” and the validity of an electronic signature value generated with SSM.BS may be verified using the PSM.BS.) As a result of this verification, if the information received from the BS is determined to be valid, the UE may perform an operation that the UE is required to perform.

FIG. 3 illustrates a process of transmitting and receiving information for identifying authenticity of a base station according to an embodiment of the disclosure.

In S310, one or more of the following processes may be performed.

The UE 301 may perform one or more of the following processes.

The UE 301 may transmit, to the BS 303, information indicating information that requires verification. In this case, the information that requires verification may be one or more of the following pieces of information:

Information received from the BS in S230 of FIG. 2; and/or

Additional information required in addition to the information received from the BS in S230 of FIG. 2.

In S320, one or more of the following processes may be performed.

The BS may perform one or more of the following processes.

The BS may transmit, to the UE, one or more of the following pieces of information:

All or part of the information requested to be verified by the UE in S310 (for example, when the information has already been transmitted to the UE in S230 of FIG. 2, it may be omitted);

TS.BS: time information generated by the BS. The UE may later use this time information to identify that the information received from the BS has not been reused;

Sig.BS: an electronic signature value generated using SSM.BS for all or part of the information; and/or

PSM.BS.

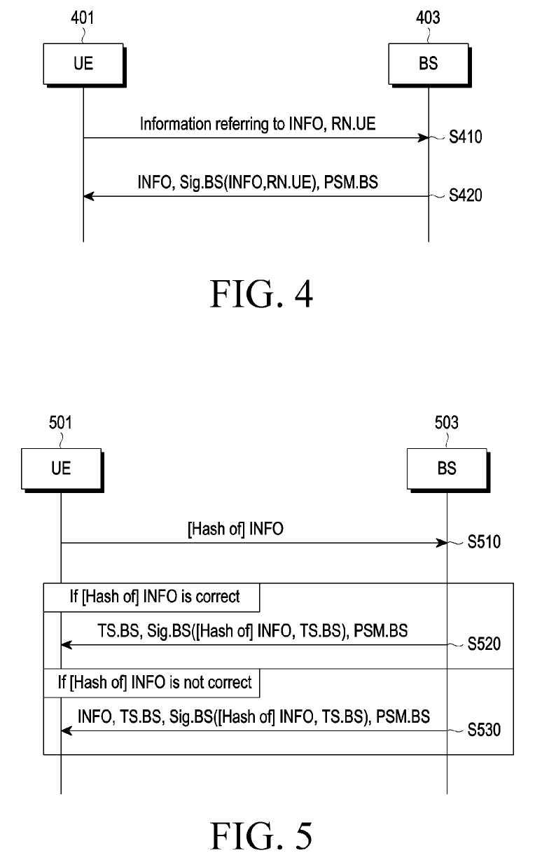

FIG. 4 illustrates a process of transmitting and receiving information for identifying authenticity of a base station according to an embodiment of the disclosure.

In S410, one or more of the following processes may be performed.

The UE 401 may perform one or more of the following processes:

The UE 401 may transmit, to the BS 403, information indicating information that requires verification. In this case, the information that requires verification may include one or more of the following pieces of information:

Information received from the BS in S230 of FIG. 2, and/or

Additional information required in addition to the information received from the BS in S230 of FIG. 2; and/or

The UE may transmit, to the BS, one or more of the following pieces of information:

RN.UE: an RN generated by the UE.

In S420, one or more of the following processes may be performed.

The BS 403 may perform one or more of the following processes.

The BS may transmit, to the UE, one or more of the following pieces of information:

All or part of the information requested to be verified by the UE in S410 (for example, when the information has already been transmitted to the UE in S230 of FIG. 2, it may be omitted);

Sig.BS: an electronic signature value generated using SSM.BS for information including “all or part of the information” and/or “RN.UE received in S410”; and/or

PSM.BS.

FIG. 5 illustrates a process of transmitting and receiving information for identifying authenticity of a base station according to an embodiment of the disclosure.

In S510, one or more of the following processes may be performed.

The UE 501 may perform one or more of the following processes.

The UE 501 may transmit, to the BS 503, one or more of the following pieces of information:

INFO received in S230 of FIG. 2 and/or a hash value thereof; and/or

Information indicating additional information that is required to be provided by the BS in addition to the INFO received in S230 of FIG. 2.

In S520, one or more of the following processes may be performed.

When the UE has not requested verification of additional information other than the INFO received in S230 of FIG. 2, and the value transmitted by the UE in S510 is determined to be a valid value, the BS may perform one or more of the following processes.

The BS may transmit, to the UE, one or more of the following pieces of information:

TS.BS: time information generated by the BS. The UE may later use this time information to identify that the information received from the BS has not been reused;

Sig.BS: an electronic signature value generated using SSM.BS for information including TS.BS and/or “the value received from the UE in S510” or a hash value thereof; and/or

PSM.BS.

In S530, one or more of the following processes may be performed.

When the UE has requested verification of additional information other than the INFO received in S230 of FIG. 2, or the value transmitted by the UE in S530 is determined to be invalid, the BS may perform one or more of the following processes.

The BS may transmit, to the UE, one or more of the following pieces of information:

INFO: the additional information requested by the UE in S510 and/or the INFO that may have been received by the UE in S230 of FIG. 2;

TS.BS: time information generated by the BS. The UE may later use this time information to identify that the information received from the BS has not been reused ;

Sig.BS: an electronic signature value generated using SSM.BS for information including “all or a part of the value” and/or “a hash value of all or a part of the value”; and/or

PSM.BS.

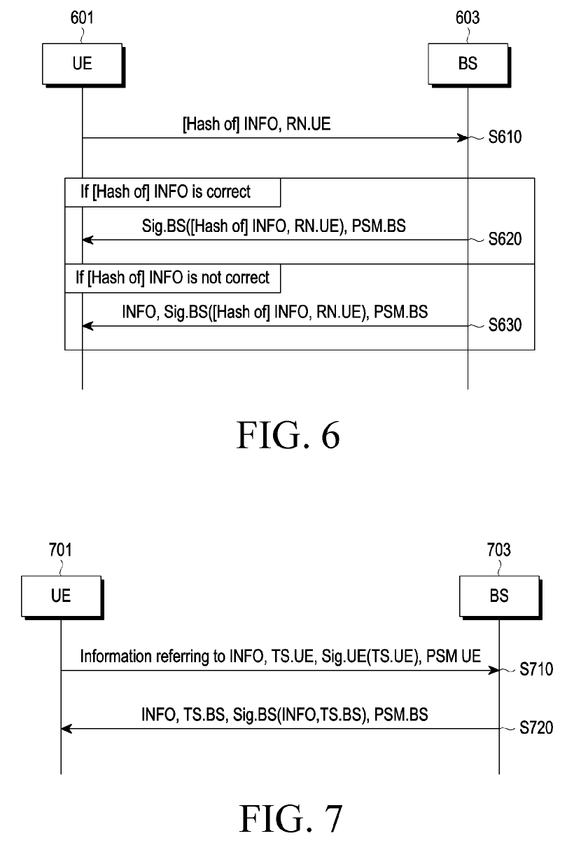

FIG. 6 illustrates a process of transmitting and receiving information for identifying authenticity of a base station according to an embodiment of the disclosure.

In S610, one or more of the following processes may be performed.

The UE 601 may perform one or more of the following processes.

The UE 601 may transmit, to the BS 603, one or more of the following pieces of information:

INFO received in S230 of FIG. 2 and/or a hash value thereof, and/or

Information indicating additional information that is required to be provided by the BS in addition to the INFO received in S230 of FIG. 2; and/or

The UE may transmit, to the BS, one or more of the following pieces of information:

RN.UE: an RN generated by the UE.

In S620, one or more of the following processes may be performed.

When the UE has not requested verification of additional information other than the INFO received in S230 of FIG. 2, and the value transmitted by the UE in S610 is determined to be a valid value, the BS may perform one or more of the following processes.

The BS may transmit, to the UE, one or more of the following pieces of information:

Sig.BS: an electronic signature value generated using SSM.BS for information including “all or a part of the value received from the UE in S610” and/or “a hash value of all or a part of the value received from the UE in S610”; and/or

PSM.BS.

In S630, one or more of the following processes may be performed.

When the UE has requested verification of additional information other than the INFO received in S230 of FIG. 2, or the value transmitted by the UE in S610 is determined to be invalid, the BS may perform one or more of the following processes.

The BS may transmit, to the UE, one or more of the following pieces of information:

INFO: the additional information requested by the UE in S610 and/or the INFO that may have been received by the UE in S230 of FIG. 2;

Sig.BS: an electronic signature value generated using SSM.BS for information including “all or part of the INFO and RN.UE” and/or “a hash value of all or part of the INFO and RN.UE”; and/or

PSM.BS.

FIG. 7 illustrates a process of transmitting and receiving information for identifying authenticity of a base station according to an embodiment of the disclosure.

In S710, one or more of the following processes may be performed.

The UE may perform one or more of the following processes:

The UE may transmit, to the BS, information indicating information that requires verification. In this case, the information that requires verification may include one or more of the following pieces of information;

Information received from the BS in S230 of FIG. 2, and/or

Additional information required in addition to the information received from the BS in S230 of FIG. 2;

TS.UE: time information generated by the UE. The BS may later use this time information to identify that the information received from the UE has not been reused;

Sig.UE: an electronic signature value generated using SSM.UE for information including all or a part of the value; and/or

PSM.UE.

In S720, one or more of the following processes may be performed.

The BS may perform one or more of the following processes:

The BS may verify authenticity of the information transmitted by the UE. This process may include one or more of the following processes;

The BS may verify validity of PSM.UE received in S710 using means for verifying PSM.UE possessed by the BS, and/or

When PSM.UE is determined to be valid, the BS may verify authenticity of Sig.UE using the PSM.UE; and/or

When the verification result indicates that the message transmitted by the UE is valid, the BS may transmit, to the UE, one or more of the following pieces of information:

All or part of the information requested to be verified by the UE in S710 (for example, when the information has already been transmitted to the UE in S230 of FIG. 2, it may be omitted),

TS.BS: time information generated by the BS. The UE may later use this time information to identify that the information received from the BS has not been reused,

Sig.BS: an electronic signature value generated using SSM.BS for information including all or part of the information; and/or

PSM.BS.

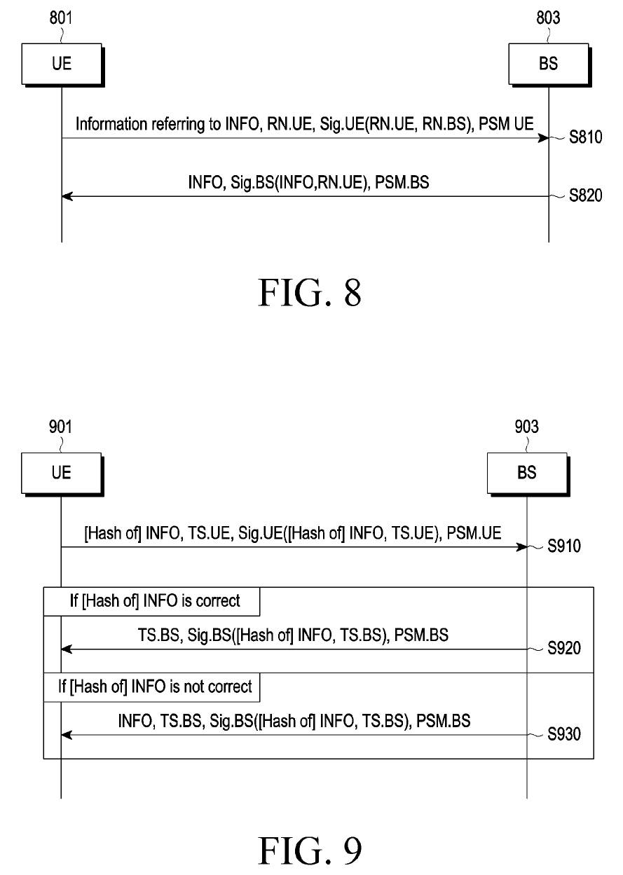

FIG. 8 illustrates a process of transmitting and receiving information for identifying authenticity of a base station according to an embodiment of the disclosure.

In S810, one or more of the following processes may be performed.

The UE 801 may perform one or more of the following processes:

The UE 801 may transmit, to the BS 803, information indicating information that requires verification. In this case, the information that requires verification may include one or more of the following pieces of information:

Information received from the BS in S230 of FIG. 2, and/or

Additional information required in addition to the information received from the BS in S230 of FIG. 2;

RN.UE: an RN generated by the UE,

Sig.UE: an electronic signature value generated using SSM.UE for information including “all or a part of the value” and/or “RN.BS,” and/or

PSM.UE.

In S820, one or more of the following processes may be performed.

The BS may perform one or more of the following processes:

The BS may verify authenticity of the information transmitted by the UE. This process may include one or more of the following processes:

The BS may verify validity of PSM.UE received in S810 using means for verifying PSM.UE possessed by the BS;

When PSM.UE is determined to be valid, the BS may verify authenticity of Sig.UE using the PSM.UE, and/or

When the verification result indicates that the message transmitted by the UE is valid, the BS may transmit, to the UE, one or more of the following pieces of information:

All or part of the information requested to be verified by the UE in S810 (for example, when the information has already been transmitted to the UE in S230 of FIG. 2, it may be omitted);

Sig.BS: an electronic signature value generated using SSM.BS for information including “all or part of the information” and/or “RN.UE received in S810”; and/or

PSM.BS.

FIG. 9 illustrates a process of transmitting and receiving information for identifying authenticity of a base station according to an embodiment of the disclosure.

In S910, one or more of the following processes may be performed.

The UE may perform one or more of the following processes.

The UE may transmit, to the BS, one or more of the following pieces of information:

INFO received in S230 of FIG. 2 and/or a hash value thereof;

Information indicating additional information that is required to be provided by the BS in addition to the INFO received in S230 of FIG. 2;

TS.UE: time information generated by the UE. The BS may later use this time information to identify that the information received from the UE has not been reused;

Sig.UE: an electronic signature value generated using SSM.UE for information including “all or a part of the value” and/or “a hash value of all or a part of the value”; and/or

PSM.UE.

In S920, one or more of the following processes may be performed.

The BS may verify authenticity of the information transmitted by the UE. This process may include one or more of the following processes:

The BS may verify validity of PSM.UE received in S910 using means for verifying PSM.UE possessed by the BS; and/or

When PSM.UE is determined to be valid, the BS may verify authenticity of Sig.UE using the PSM.UE.

When the verification result indicates that the message transmitted by the UE is valid, the following operations may be performed. When the UE has not requested verification of additional information other than the INFO received in S230 of FIG. 2, and the value transmitted by the UE in S910 is determined to be a valid value, the BS may perform one or more of the following processes.

The BS may transmit to the UE one or more of the following pieces of information:

TS.BS: time information generated by the BS. The UE may later use this time information to identify that the information received from the BS has not been reused;

Sig.BS: an electronic signature value generated using SSM.BS for information including TS.BS and/or the value received from the UE in S910 or a hash value thereof; and/or

PSM.BS.

In S930, one or more of the following processes may be performed.

The BS may verify authenticity of the information transmitted by the UE. This process may include one or more of the following processes:

The BS may verify validity of PSM.UE received in S910 using means for verifying PSM.UE possessed by the BS; and/or

When PSM.UE is determined to be valid, the BS may verify authenticity of Sig.UE using the PSM.UE.

When the verification result indicates that the message transmitted by the UE is valid, the following operations may be performed. When the UE has requested verification of additional information other than the INFO received in S230 of FIG. 2 or the value transmitted by the UE in S910 is determined to be invalid, the BS may perform one or more of the following processes.

The BS may transmit, to the UE, one or more of the following pieces of information:

INFO: the additional information requested by the UE in S910 and/or the INFO that may have been received by the UE in S230 of FIG. 2;

TS.BS: time information generated by the BS. The UE may later use this time information to identify that the information received from the BS has not been reused;

Sig.BS: an electronic signature value generated using SSM.BS for information including “all or a part of the value” and/or “a hash value of all or a part of the value”; and/or

PSM.BS.

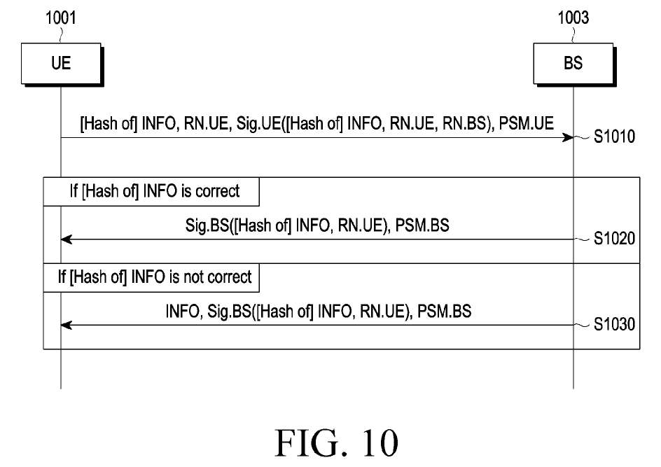

FIG. 10 illustrates a process for identifying the authenticity of a base station according to an embodiment of the disclosure.

In S1010, one or more of the following processes may be performed.

The UE 1001 may perform one or more of the following processes.

UE 1001 may transmit one or more of the following pieces of information to BS 1003:

INFO received in S230 of FIG. 2 and/or a hash value thereof;

Information indicating additional information to be provided by a BS other than the INFO received in S230 of FIG. 2;

RN. UE: RN generated by the UE;

Sig. UE: an electronic signature value generated using SSM.UE for information including “all or a part of the value, and/or a hash value of all or a part the value, and/or RN.BS; and/or

PSM UE.

In S1020, one or more of the following processes may be performed.

The BS may verify the authenticity of the information transmitted by the UE. This process may include one or more of the following processes:

The BS may verify the validity of the PSM.UE received in S1010 by using a means capable of verifying the PSM.UE held by the BS’ and/or

When the PSM.UE is determined to be valid, the BS may verify the authenticity of the Sig.UE by using the PSM.UE.

When, as a result of the verification, the message transmitted by the UE is determined to be valid, the following operation may be performed. When the UE does not request verification for additional information other than the INFO received in S230 of FIG. 2, and the value transmitted by the UE in S1010 is determined to be correct, the BS may perform one or more of the following processes.

The BS may transmit, to the UE, one or more of the following pieces of information:

Sig.BS: an electronic signature value generated using SSM.BS for information including RN.UE and/or “all or a part of the value received from the UE in S1010” and/or “a hash value of all or a part of the value received from the UE in S1010”; and/or

PSM.BS.

In S1030, one or more of the following processes may be performed.

The BS may verify the authenticity of the information transmitted by the UE. This process may include one or more of the following operations:

The BS may verify the validity of the PSM.UE received in S1010 by using a means capable of verifying the PSM.UE held by the BS; and/or

When the PSM.UE is determined to be valid, the BS may verify the authenticity of the Sig.UE by using the PSM.UE.

When, as a result of the verification, the message transmitted by the UE is determined to be valid, the following operation may be performed. When the UE requests verification for additional information other than the INFO received in S230 of FIG. 2, or when the value transmitted by the UE in S1010 is determined to be incorrect, the BS may perform one or more of the following processes.

The BS may transmit, to the UE, one or more of the following pieces of information:

INFO: information that the UE requested to be additionally verified in S1010 and/or the INFO that may have been received by the UE in S230 of FIG. 2;

Sig.BS: an electronic signature value generated using SSM.BS for information including “RN.UE and all or a part of the value” and/or “RN.UE and a hash value of all or a part of the value”; and/or

PSM.BS.

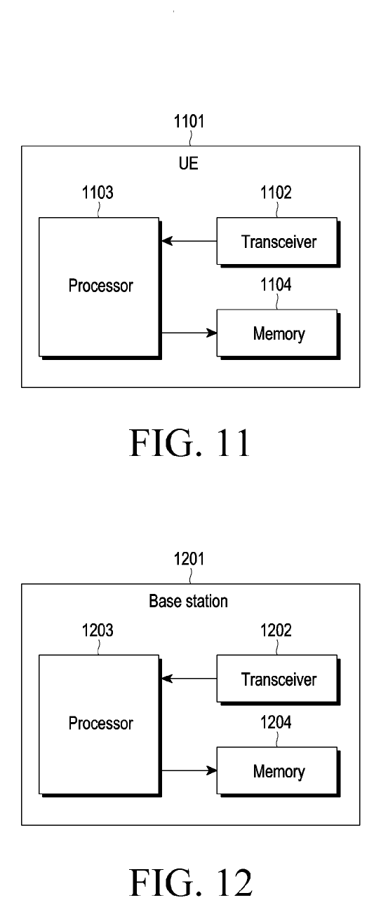

FIG. 11 illustrates a structure of a UE according to an embodiment of the disclosure. Referring to FIG. 11, the UE in FIG. 11 may be implemented as the terminal or the electronic device illustrated in FIG. 1 to FIG. 10.

Referring to FIG. 11, the electronic device may include a transceiver 1102, a processor 1103, and memory 1104. As used herein, the processor may be defined as a circuit, an application specific integrated circuit, or at least one processor.

The transceiver 1102 may transmit/receive signals with an external electronic device.

The processor 1103 may control the overall operation of the electronic device according to the embodiments provided in the disclosure. For example, the processor 1103 may control signal flows between the respective blocks to perform operations according to the above-described flowcharts. Specifically, the processor 1103 may control, for example, the operation of the wireless station illustrated in FIG. 1 to FIG. 10.

The memory 1104 may store at least one of information transmitted/received through the transceiver 1102 and information generated through the processor 1103.

FIG. 12 illustrates a structure of a base station according to an embodiment of the disclosure. The base station in FIG. 12 may be implemented as the network entity or, the electronic device illustrated in FIG. 1 to FIG. 10.

Referring to FIG. 12, the base station may include a transceiver 1202, a processor 1203, and memory 1204. As used herein, the processor may be defined as a circuit, an application specific integrated circuit, or at least one processor.

The transceiver 1202 may transmit/receive signals with an external electronic device.

The processor 1203 may control the overall operation of the electronic device according to the embodiments provided in the disclosure. For example, the processor 1203 may control signal flows between the respective blocks to perform operations according to the above-described flowcharts. Specifically, the processor 1203 may control, for example, the operation of the base station or electronic device illustrated in FIG. 1 to FIG. 10.

The memory 1204 may store at least one of information transmitted/received through the transceiver 1202 and information generated through the processor 1203.

It should be noted that system configuration diagrams, method illustrations, and signal flowcharts illustrated in FIGS. 1 to 12 are not intended to limit the scope of protection of the disclosure. That is, all the constituent units or operation steps shown in FIGS. 1 to 12 should not be construed as essential elements for implementing the disclosure, and even when including only some of the elements, the disclosure may be implemented without impairing the true nature of the disclosure.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE) for identifying a base station in a communication system, the method comprising:
identifying a first secret signing key used for a signature of the UE, a first public key of the UE that enables verification of a first signature value signed with the first secret signing key, and proof information indicating that the first public key is owned by the UE;
receiving, from the base station, a second public key of the base station that enables verification of a second signature value signed with a second secret signing key used for a signature of the base station; and
verifying authenticity of the base station based on the first public key of the UE and the second public key of the base station.

2. The method of claim 1, further comprising:
identifying means for verifying proof information indicating that the second public key of the base station that enables verification of the second signature value.

3. The method of claim 1, further comprising:
receiving, from the base station, a first message comprising first information required in a process in which the UE camps on the base station,
wherein the first information comprises at least one of cell selection parameters, neighbor cell information, frequency priority, block listed cell information, common channel configuration information, or a public warning system (PWS) message.

4. The method of claim 3, wherein the first message further comprises at least one of second information indicating that the base station is equipped with a base station authenticity verification function or third information used in a process of verifying the UE by the base station.

5. The method of claim 4, further comprising:
transmitting, to the base station, a second message comprises at least one of the first information, the second information, or the third information; and
receiving, from the base station, a third message comprising time information generated by the base station, and an electronic signature value generated based on the second secret signing key used for a signature of the base station.

6. A method of a base station in a communication system, the method comprising:
identifying a second secret signing key used for a signature of the base station, a second public key of the base station that enables verification of a second signature value signed with the second secret signing key, and proof information indicating that the second public key is owned by the base station; and
transmitting, to a user equipment (UE), the second public key of the base station to verify authenticity of the base station based on a first public key of the UE that enables verification of a first signature value signed with a first secret signing key, and the second public key of the base station.

7. The method of claim 6, further comprising:
identifying means for verifying proof information indicating that the first public key of the UE that enables verification of the first signature value.

8. The method of claim 6, further comprising:
transmitting, to the UE, a first message comprising first information required in a process in which the UE camps on the base station,
wherein the first information comprises at least one of cell selection parameters, neighbor cell information, frequency priority, block listed cell information, common channel configuration information, or a public warning system (PWS) message.

9. The method of claim 8, wherein the first message further comprises at least one of second information indicating that the base station is equipped with a base station authenticity verification function or third information used in a process of verifying the UE by the base station.

10. The method of claim 9, further comprising:
receiving, from the UE, a second message comprises at least one of the first information, the second information, or the third information; and
transmitting, to the UE, a third message comprising time information generated by the base station, and an electronic signature value generated based on the second secret signing key used for a signature of the base station.

11. A user equipment (UE) for identifying a base station in a communication system, the UE comprising:
a transceiver; and
a processor coupled with the transceiver, the processor is configured to:
identify a first secret signing key used for a signature of the UE, a first public key of the UE that enables verification of a first signature value signed with the first secret signing key, and proof information indicating that the first public key is owned by the UE;
receive, from the base station, a second public key of the base station that enables verification of a second signature value signed with a second secret signing key used for a signature of the base station; and
verify authenticity of the base station based on the first public key of the UE and the second public key of the base station.

12. The UE of claim 11, wherein the processor is configured to:
identify means for verifying proof information indicating that the second public key of the base station that enables verification of the second signature value.

13. The UE of claim 11, wherein the processor is configured to:
receive, from the base station, a first message comprising first information required in a process in which the UE camps on the base station,
wherein the first information comprises at least one of cell selection parameters, neighbor cell information, frequency priority, block listed cell information, common channel configuration information, or a public warning system (PWS) message.

14. The UE of claim 13, wherein the first message further comprises at least one of second information indicating that the base station is equipped with a base station authenticity verification function or third information used in a process of verifying the UE by the base station.

15. The UE of claim 14, wherein the processor is configured to:
transmit, to the base station, a second message comprises at least one of the first information, the second information, or the third information; and
receive, from the base station, a third message comprising time information generated by the base station, and an electronic signature value generated based on the second secret signing key used for a signature of the base station.

16. A base station in a communication system, the base station comprising:
a transceiver; and
a processor coupled with the transceiver, the processor is configured to:
identify a second secret signing key used for a signature of the base station, a second public key of the base station that enables verification of a second signature value signed with the second secret signing key, and proof information indicating that the second public key is owned by the base station; and
transmit, to a user equipment (UE), the second public key of the base station to verify authenticity of the base station based on a first public key of the UE that enables verification of a first signature value signed with a first secret signing key, and the second public key of the base station.

17. The base station of claim 16, wherein the processor is configured to:
identify means for verifying proof information indicating that the first public key of the UE that enables verification of the first signature value.

18. The base station of claim 16, wherein the processor is configured to:
transmit, to the UE, a first message comprising first information required in a process in which the UE camps on the base station,
wherein the first information comprises at least one of cell selection parameters, neighbor cell information, frequency priority, block listed cell information, common channel configuration information, or a public warning system (PWS) message.

19. The base station of claim 18, wherein the first message further comprises at least one of second information indicating that the base station is equipped with a base station authenticity verification function or third information used in a process of verifying the UE by the base station.

20. The base station of claim 19, wherein the processor is configured to:
receive, from the UE, a second message comprises at least one of the first information, the second information, or the third information; and
transmit, to the UE, a third message comprising time information generated by the base station, and an electronic signature value generated based on the second secret signing key used for a signature of the base station.
